(19) United States
(12) Patent Application Publication
(10) Pub. No.: US 2026/0010740 A1
(43) Pub. Date: Jan. 8, 2026

(54) DEVICE AND METHOD FOR PERFORMING A NETWORK TEST WITH REGIONAL LANGUAGE SUPPORT

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Sundaresh SANKARAN, Mumbai (IN); Haresh B AMBALIYA, Guharat (IN); Premprakash BHAKAR, Maharashtra (IN); Yogita Gunjal ROMAN, Madhya Pradesh (IN); Rahul GOYAL, Madhya Pradesh (IN); Surya CHUNDAWAT, Rajasthan (IN)

(73) Assignee: JIO PLATFORMS LIMITED, Ahmedabad (IN)

(21) Appl. No.: 18/993,345

(22) PCT Filed: May 29, 2024
(86) PCT No.: PCT/IN2024/050636

§ 371 Date: Jan. 10, 2025

(30) Foreign Application Priority Data
Jun. 28, 2023 (IN) 20232143413

(51) Int. Cl. G06F 40/58; G06F 3/0482; G06F 3/16; H04L 41/22

(52) U.S. Cl. CPC G06F 40/58; H04L 41/22; G06F 3/0482; G06F 3/167

(57) ABSTRACT

The present disclosure provides a user device (104) and method (600) for performing a network test. The method comprising receiving (602), by a receiving unit (202), an input command from a user (102). The method comprising detecting (604), by a processing unit (208), a language of the received input command. The method comprising processing (606), by the processing unit (208), the input command to convert the detected language into a machine language. The method comprising performing (608), by a testing unit (212), the network test based on the processed input command. The method comprising converting (610), by the processing unit (208), a result of the network test in the detected language. The method comprising rendering (612) the result of the network test to the user (102) in the detected language.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to mobile application technology. In particular, the present disclosure relates to a device and method for performing a network test with regional language support.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Wireless communication technology has rapidly evolved over the past few decades. The first generation of wireless communication technology was analog technology that offered only voice services. Further, when the second-generation (2G) technology was introduced, text messaging and data services became possible. The 3G technology marked the introduction of high-speed internet access, mobile video calling, and location-based services. The fourth generation (4G) technology revolutionized the wireless communication with faster data speeds, improved network coverage, and security. Fifth generation (5G) and advanced-generation technology are being deployed, with even faster data speeds, low latency, and the ability to connect multiple devices simultaneously.

As the mobile networks continues to grow, users are increasingly concerned about the quality and performance of their network connections. The need for reliable signal strength and throughput information has become essential for users to make informed decisions about their network providers. The existing network applications often present technical details and parameters that may not be easily understood by the average user. The complexity of the information provided can be overwhelming, especially for individuals who are not familiar with network terminology and concepts.

Conventional network applications face difficulty in addressing the readability and comprehension issues commonly associated with network applications. There, is therefore, a need in the art to provide a user device and a method that can overcome the shortcomings of the existing prior arts.

### OBJECTS OF THE PRESENT DISCLOSURE

Some of the objects of the present disclosure, which at least one embodiment herein satisfies are as listed herein below.

An object of the present disclosure is to provide a user device and a method where the voice assistance technology helps in assisting users to provide voice commands in their regional language to eliminate manual intervention and enhance the network testing process.

An object of the present disclosure is to provide a user device and a method to support running tests and displaying results in the user's regional language to facilitate better understanding of network conditions and help users identify operators with good coverage and performance.

An object of the present disclosure is to provide a user device and a method to develop a mobile application processing user voice commands and convert them into machine-readable language.

An object of the present disclosure is to provide a user device and a method where a mobile application performs network tests based on the user's input (either in voice input or a text input) and displays the results in the requested language.

An object of the present disclosure is to provide a user device and a method to educate customers about the network conditions in their area by providing information on internet speed test results, video streaming performance, and web performance test.

### SUMMARY

In an exemplary embodiment, the present invention discloses a method for performing a network test. The method comprising, receiving, by a receiving unit, an input command from a user. The method comprising, detecting, by a processing unit, a language of the received input command. The method comprising processing, by the processing unit, the input command to convert the detected language into a machine language. The method comprising, performing, by a testing unit, the network test based on the processed input command. The method comprising, converting, by the processing unit, a result of the network test in the detected language. The method comprises, rendering the result of the network test to the user in the detected language.

In an embodiment, the method further comprising providing a list of options to the user to select the language for performing the network test.

In an embodiment, the selected language comprises of at least one of a default language and a regional language of the user.

In an embodiment, the input command includes at least one of a voice input and a text input.

In an embodiment, prior to receiving the voice input, the method comprises installing a voice assistant configured to be activated based on at least one of the voice input from the user and the geographical location of the user.

In an embodiment, the voice input comprising of a plurality of instructions to perform the network test.

In an embodiment, the method further comprising performing a natural language processing (NLP) on the voice input and using a geographical location of the user to detect the language of the voice input.

In an embodiment, the network test comprising at least one of a video streaming test, an internet speed test, and a web performance test.

In an embodiment, the network test is performed for at least one of a long term evolution (LTE), Wi-Fi and a 5G communication network.

In an embodiment, the result of the network test depends on at least one threshold value associated with at least one parameter related to the network test.

In an embodiment, the at least one parameter is different for the video streaming test, the internet speed test, and the web performance test.

In an embodiment, the at least one threshold value associated with the at least one parameter is different for the LTE, Wi-Fi and the 5G communication network.

In an exemplary embodiment, the present disclosure discloses a user device for performing a network test. The user device comprising a receiving unit configured to receive an input command from a user, a database configured to store the received input command. The user device comprising a processing unit and a testing unit coupled to the receiving unit and the database. The processing unit configured to detect a language of the received input command and process the input command to convert the detected language into a machine language. The testing unit configured to configured to perform the network test based on the processed input command. The processing unit configured to convert a result of the network test in the detected language and render the result of the network test to the user in the detected language.

In an embodiment, the user device further configured to provide a list of options to the user to select the language for performing the network test.

In an embodiment, the selected language comprises of at least one of a default language and a regional language of the user.

In an embodiment, the input command includes at least one of a voice input and a text input.

In an embodiment, prior to receiving the voice input, the user device is configured to install a voice assistant configured to be activated based on at least one of the voice input from the user and the geographical location of the user.

In an embodiment, the voice input comprising of a plurality of instructions to perform the network test.

In an embodiment, user device further configured to perform a natural language processing (NLP) on the voice input and using a geographical location of the user to detect the language of the voice input.

In an embodiment, the network test comprising at least one of a video streaming test, an internet speed test, and a web performance test.

In an embodiment, the network test is performed for at least one of a long term evolution (LTE), Wi-Fi and a 5G communication network.

In an embodiment, the result of the network test depends on at least one threshold value associated with at least one parameter related to the network test.

In an embodiment, the at least one parameter is different for the video streaming test, the internet speed test, and the web performance test.

In an embodiment, the at least one threshold value associated with the at least one parameter is different for the LTE, Wi-Fi and the 5G communication network.

### BRIEF DESCRIPTION OF DRAWINGS

The accompanying drawings, which are incorporated herein, and constitute a part of this disclosure, illustrate exemplary embodiments of the disclosed method and user device in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an example network architecture for implementing method for performing a network test with regional language support, in accordance with an embodiment of the present disclosure.

FIG. 2 illustrates an example block diagram of a user device, in accordance with an embodiment of the present disclosure.

FIG. 3A illustrates an example flow diagram for implementation of a network test with regional language support, in accordance with an embodiment of the present disclosure.

FIG. 3B illustrates another example flow diagram for implementation a network test with regional language support, in accordance with an embodiment of the present disclosure.

FIG. 4A-4I illustrates an example representation of a working model reference of a mobile application, in accordance with an embodiment of the present disclosure.

FIG. 5 illustrates an example computer system in which or with which the embodiments of the present disclosure may be implemented.

FIG. 6 illustrates a flow diagram of a method for performing a network test, in accordance with an embodiment of the present disclosure.

The foregoing shall be more apparent from the following more detailed description of the disclosure.

### LIST OF REFERENCE NUMERALS

100—Network architecture
102-1, 102-2 . . . 102-N—A plurality of users
104-1, 104-2 . . . 104-N—A plurality of computing devices
106—Network
108—Server
200—Block Diagram
202—Receiving unit
204—Memory
206—Interfacing unit
208—Processing unit
210—Database
212—Testing unit
300A—Flow diagram
300B—Flow diagram
400A-400I—A working model reference of the mobile application
500—A computer system
510—External Storage Device
520—Bus
530—Main Memory
540—Read Only Memory
550—Mass Storage Device
560—Communication Port
570—Processor
600—Flow Diagram

### DETAILED DESCRIPTION OF DISCLOSURE

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

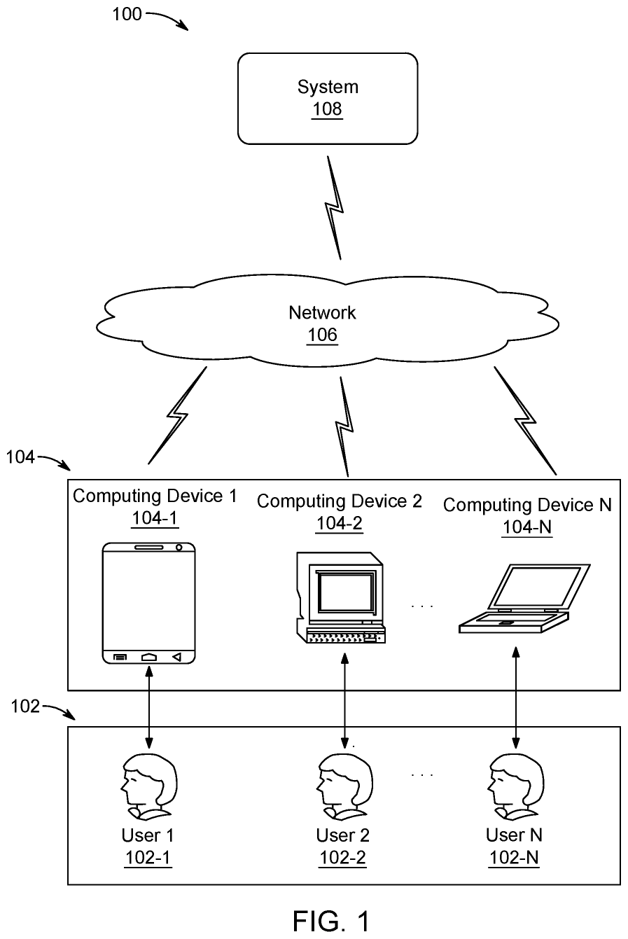

The various embodiments throughout the disclosure will be explained in more detail with reference to FIGS. 1-6.

FIG. 1 illustrates an example network architecture (100) for implementing a method for performing a network test with regional language support, in accordance with an embodiment of the present disclosure.

A server (108) may be communicatively coupled through a network (106) which is coupled to one or more computing devices (104-1, 104-2 . . . 104-N).

A person of ordinary skill in the art will understand that one or more computing devices (104-1, 104-2 . . . 104-N) may be collectively referred to as computing devices (104) and individually referred to as computing devices (104). One or more users (102-1, 102-2 . . . 102-N) may provide one or more requests to the system/server (108). A person of ordinary skill in the art will understand that one or more users (102-1, 102-2 . . . 102-N) may be collectively referred to as users (102) and individually referred to as users (102). Further, the computing devices (104) may also be referred to as user device or a user devices (104) user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof. In an aspect, the server (108) may be a computing device that collaborates with the user device (104) to perform the network test.

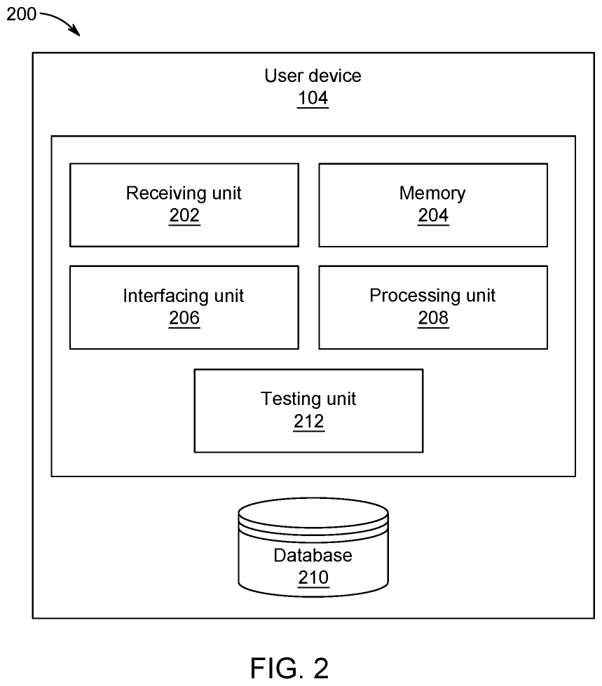

FIG. 2 illustrates an example block diagram (200) of a user device (104), in accordance with an embodiment of the present disclosure.

Referring to FIG. 2, in an embodiment, the user device (104) may include a receiving unit (202), a memory (204), an interfacing unit (206), a processing unit (208), a database (210) and a testing unit (212). The receiving unit (202) is configured to receive a voice input or a text input from a user (102) to perform the network test. The database (210) is configured to store the received voice/text input. The processing unit (208) and the testing unit (212) are coupled to the receiving unit (202) and the database (210). The processing unit (208) is configured to detect a language of the received voice/text input and process the voice/text input to convert the detected language into a machine language. The testing unit (212) is configured to perform the network test based on the processed voice/text input. The processing unit (208) is further configured to convert a result of the network test in the detected language and render the result of the network test to the user (102) in the detected language.

The processing unit (208) may be implemented as one or more microprocessors, microcomputers, microcontrollers, digital signal processors, central processing units, logic circuitries, and/or any devices that process data based on operational instructions. Among other capabilities, the processing unit (208) may be configured to fetch and execute computer-readable instructions stored in a memory (204) of the user device (104). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the interfacing unit (206) may comprise a variety of interfaces, for example, interfaces for data input and output devices (I/O), storage devices, and the like. The interfacing unit (206) may facilitate communication through the user device (104). The interfacing unit (206) may also provide a communication pathway for various components of the user device (104).

In an embodiment, the processing unit (208) is configured to detect the language of the received voice/text input. The processing unit (208) may use one or more language tools, which performs feature extraction, feature analysis, language modelling process, classification and post-processing to detect the language. The processing unit (208) may support regional languages as well as international languages. The voice/text input is processed to convert the detected language into a machine language. In examples, the processing unit (208) may use tools such as automatic speech recognition (ASR), natural language processing (NLP), etc., to convert audio input to text in corresponding language. In some examples, the processing unit (208) may use one or more language tools and geographical location to identify the language.

The network test is performed based on the processed voice/text input by the testing unit (212). The processing unit (208) is further configured to convert the result of the network test in the detected language and render the result of the network test to a user in the detected language.

Although FIG. 2 shows exemplary components of the user device (104) in other embodiments, the user device (104) may include fewer components, different components, differently arranged components, or additional functional components than depicted in FIG. 2. Additionally, or alternatively, one or more components of the user device (104) may perform functions described as being performed by one or more other components of the user device (104).

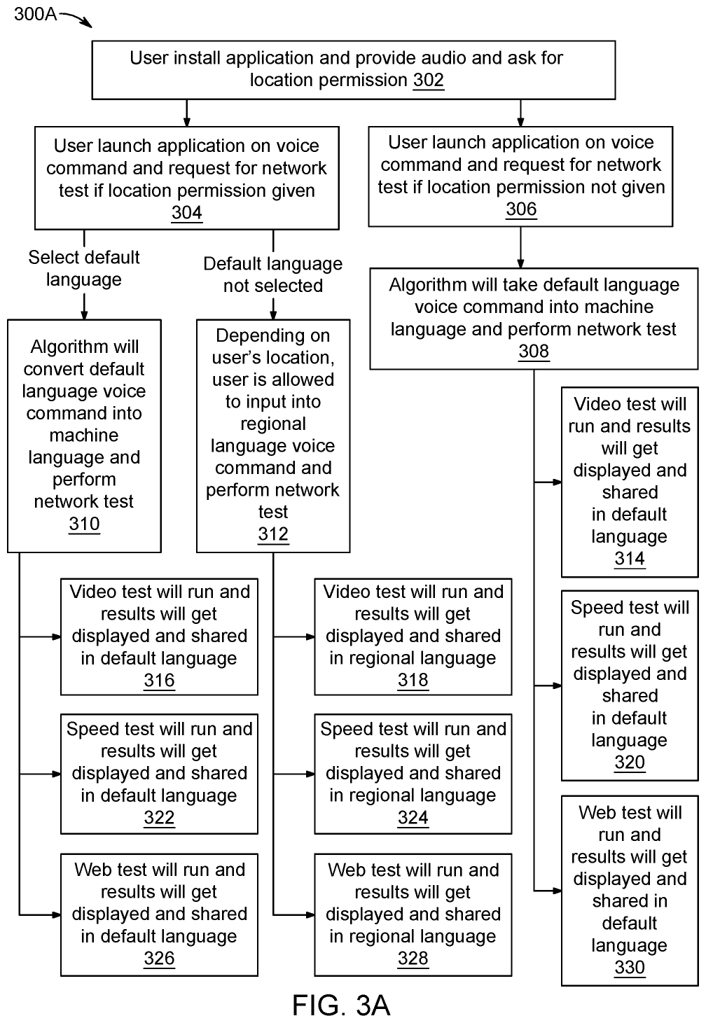

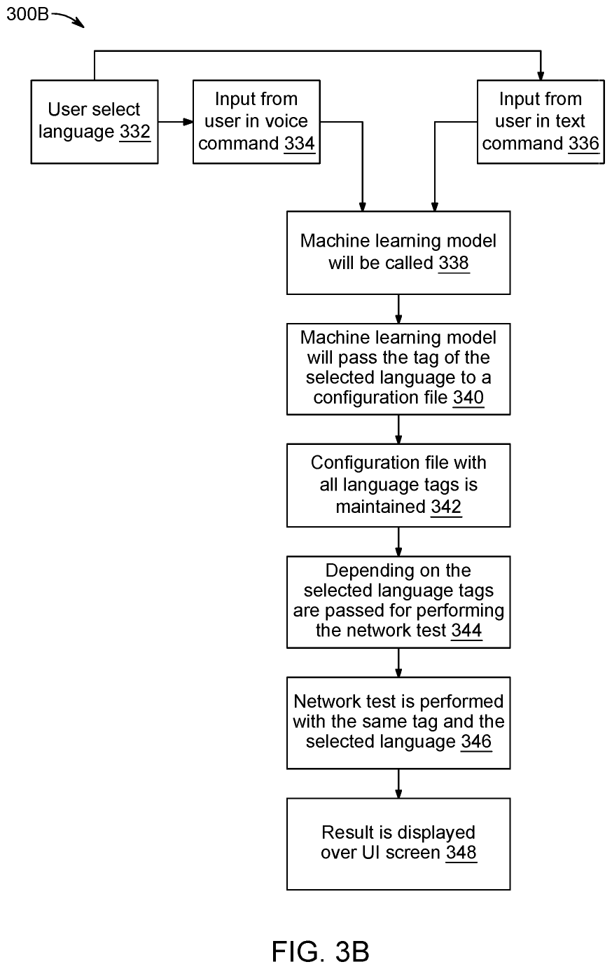

FIG. 3A illustrates an example flow diagram (300A) for implementation of a network test with regional language support, in accordance with an embodiment of the present disclosure.

As illustrated in FIG. 3A, the following steps may be implemented by the user device (104) for implementation of the network test with regional language support.

At step 302: The user (102) may install a mobile application on the user device (104). The mobile application may receive an input from the user (102) pertaining to an audio command and the user device (104) may ask for a location of the user (102). In an aspect, the input from the user (102) may include a text command from the user (102).

At step 304: The user (102) may launch the application using the voice command (audio input). The user device (104) may receive a request from the user (102) to execute a network test based on the audio input of the user (102) and based on the location permission granted by the user (102).

At step 306: The user (102) may launch the application using the voice command. The user device (104) may receive a request from the user (102) to execute the network test based on the audio input of the user (102) when the location permission is not granted by the user (102).

At step 308: The user device (104) may take the default language voice command into machine language and perform the network test. For example, a video test will run, and the results will be displayed and shared in the default language (at step 314), or a speed test will run, and the results will get displayed and shared in the default language (at step 320), or a web test will run, and the results will get displayed and shared in the default language (at step 330).

At step 310: When the user selects a default language, the user device (104) may convert the default language voice command into machine language and perform the network test. For example, a video test will run, and the results will be displayed and shared in the default language (at step 316), or a speed test will run, and the results will be displayed and shared in the default language (at step 322), or a web test will run, and the results will get displayed and shared in the default language (at step 326).

At step 312: When the default language is not selected by the user (102), then depending on the user's location, the user is allowed to input into a regional language voice command and perform the network test. For example, a video test will run, and the results will be displayed and shared in the regional language (at step 318), or a speed test will run, and the results will be displayed and shared in the regional language (at step 324), or a web test will run, and the results will get displayed and shared in the regional language (at step 328).

FIG. 3B illustrates another example flow diagram (300B) for implementation a network test with regional language support, in accordance with an embodiment of the present disclosure.

As illustrated in FIG. 3B, the following steps may be implemented by the user device (104) for implementation a network test with regional language support.

At step 332: An input is received from the user (102) in a user selected language. In an aspect, the user (102) selected language may be a user's regional language.

At step 334: The input from the user (102) may be received in a voice message/command.

At step 336: The input from the user (102) may be received in a text message/command.

At step 338: After receiving the input from the user (102) a machine learning model is called. The machine learning models are algorithms that can learn patterns and relationships from the input data, enabling them to make predictions or decisions without being explicitly programmed.

At step 340: The machine learning model passes a tag of the selected language to a configuration table. The tags refer to labels or metadata associated with the models, or the input data used to train them.

At step 342: The configuration file is maintained with screen wise tagging of the elements along with the selected language. Further, when there is any addition of a new language, the model need to be trained on the new language and corresponding entry need to be maintained in the configuration file

At step 344: The tags are passed to a nearest server to perform the network test depending on the selected language.

At step 346: A network test is performed with the same tag and the selected language.

At step 348: The network test result may get displayed over a user interface (UI) screen.

In an aspect, the various network test may include an internet speed test (speed test), a web performance test, and a video streaming performance (video test).

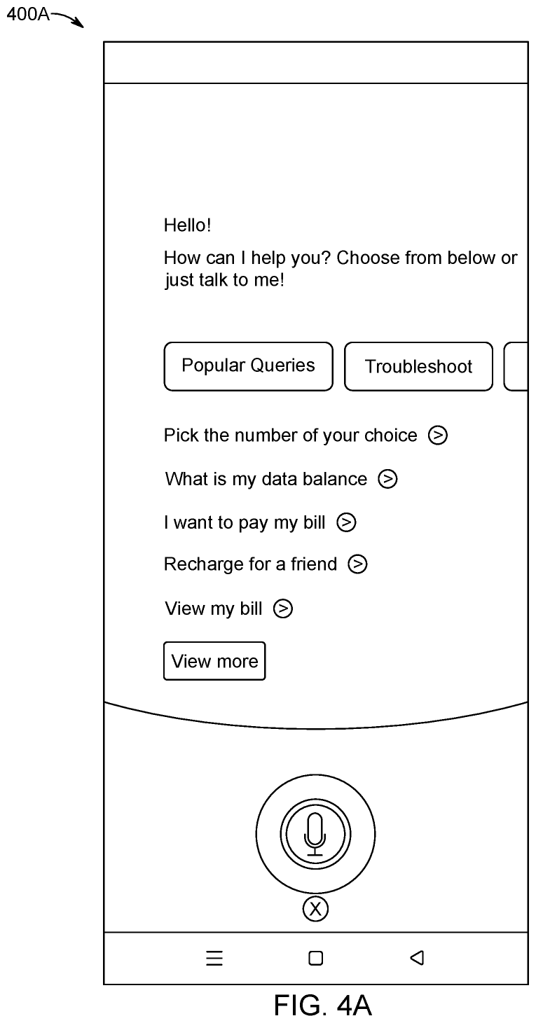

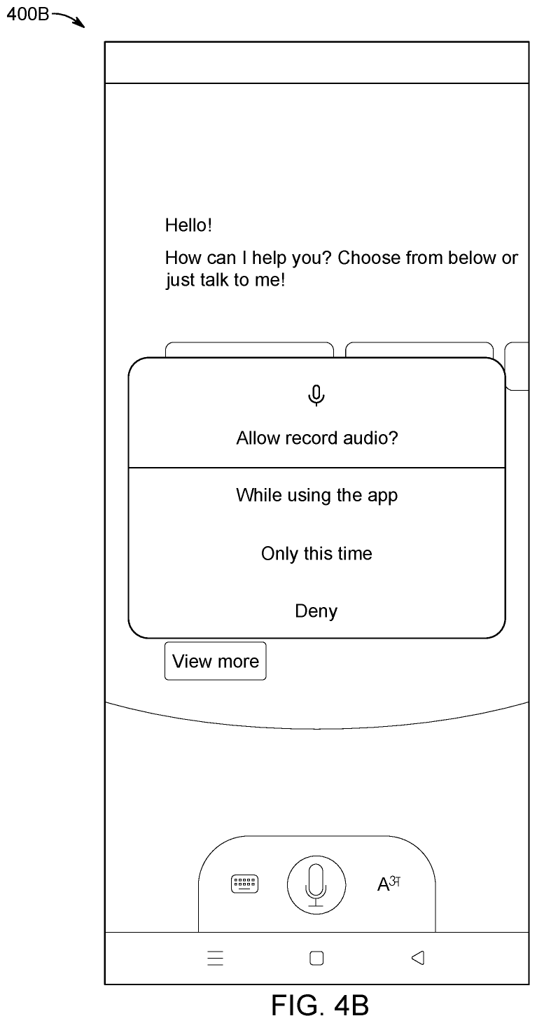

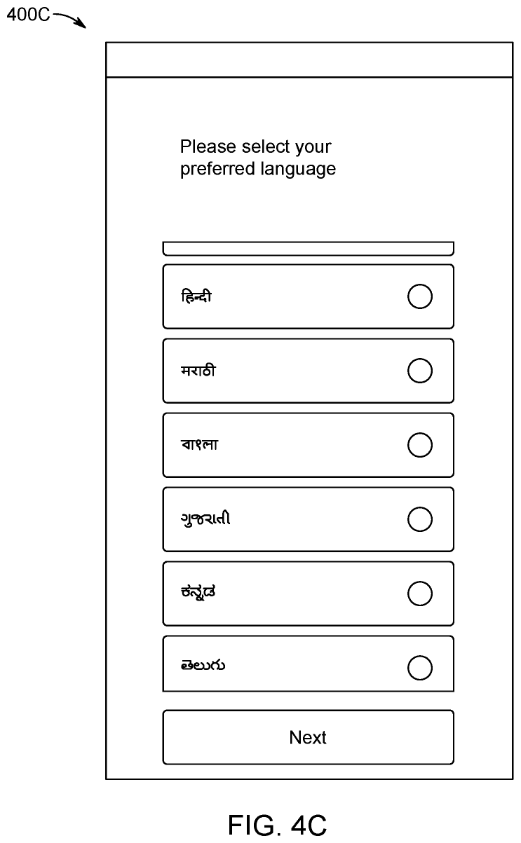

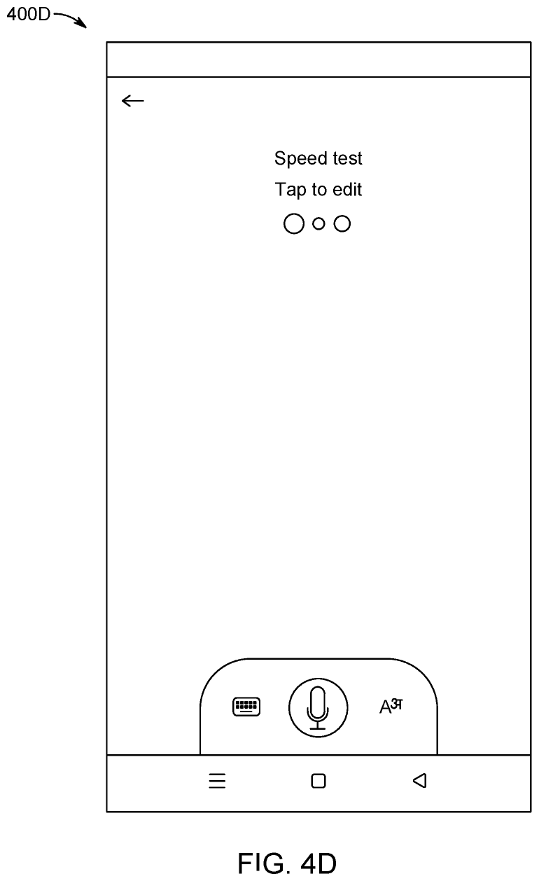

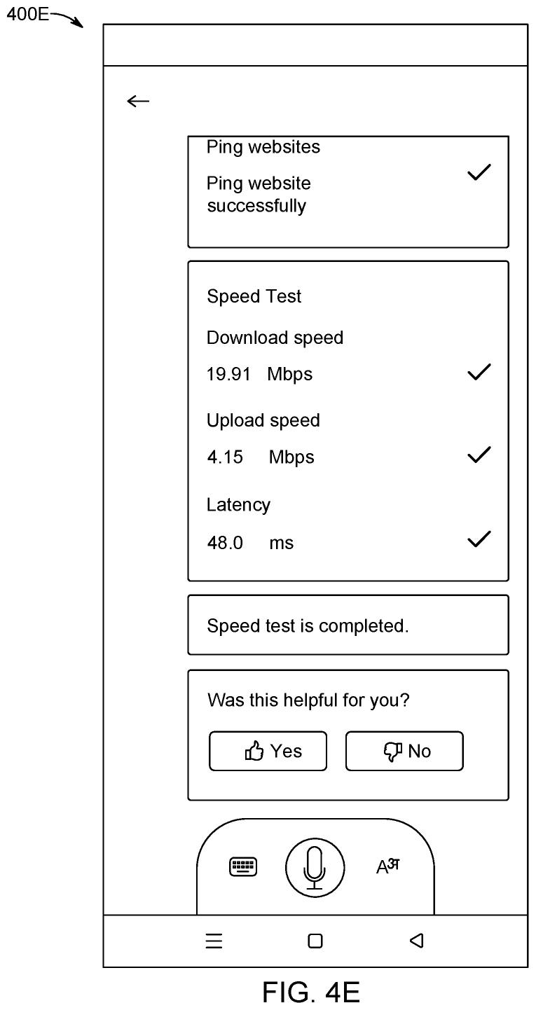

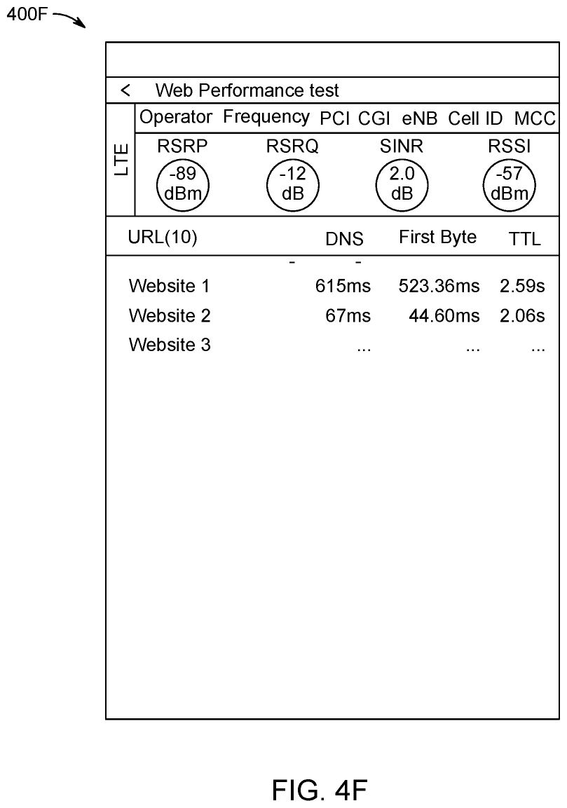

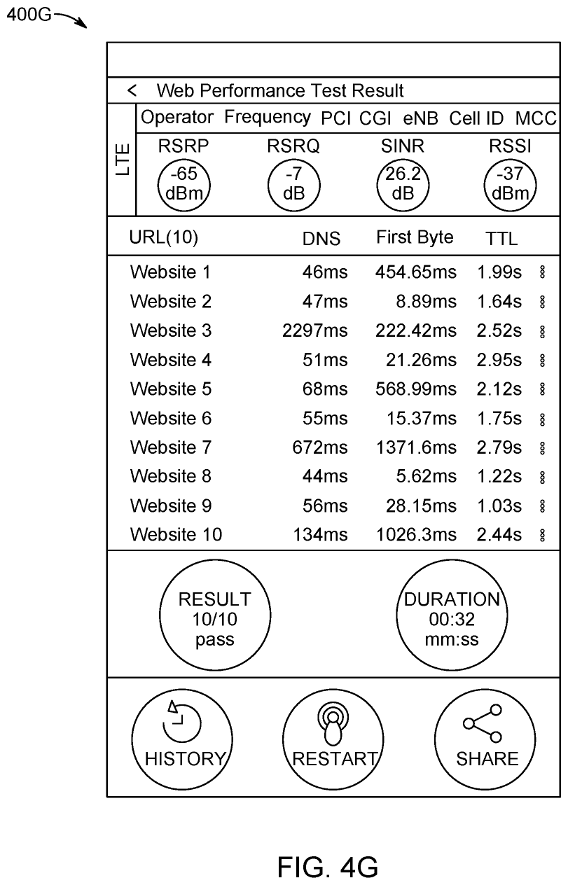

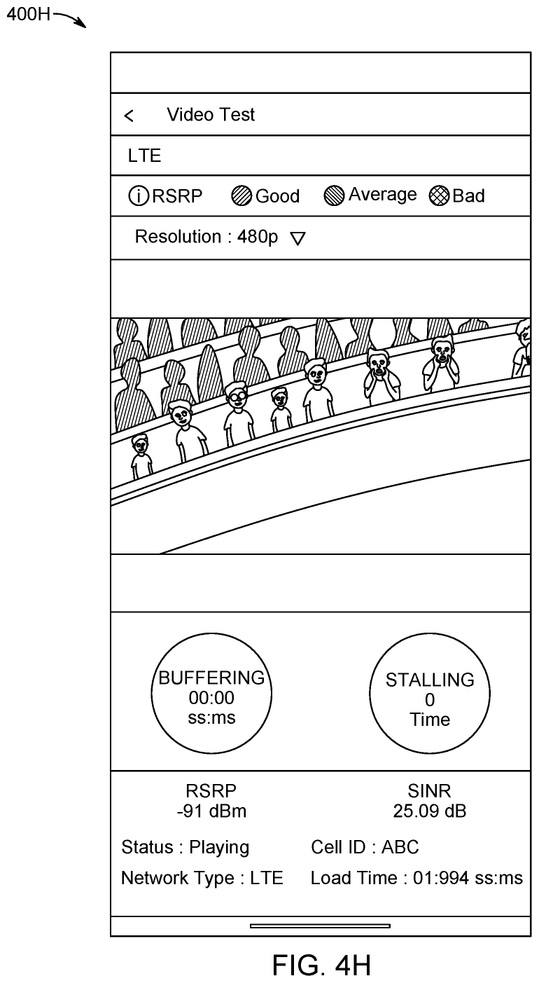

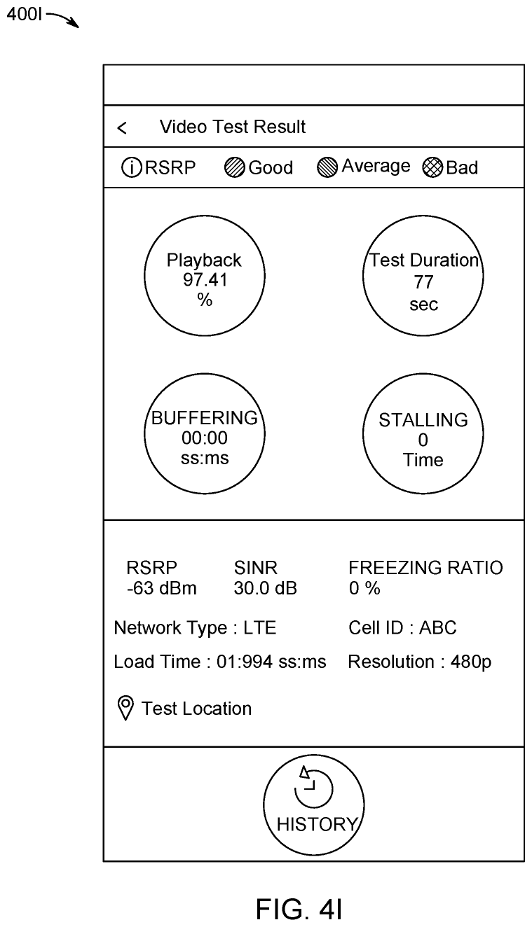

FIG. 4A-4I illustrates an example representation of a working model reference of a mobile application, in accordance with an embodiment of the present disclosure.

As illustrated in FIG. 4A, the user (102) launches the application on the user device (104). The application provides a user interface (UI) (400A) that provides the user (102) with a plurality of popular query options. For example, the UI (400A) may display popular queries “Pick the number of your choice”, “What is my data balance”, “I want to pay my bill”, “Recharge for a friend” or

“View my bill” etc. The user (102) may be allowed to record the audio (voice command) or input the text through the UI (400A).

As illustrated in FIG. 4B, the UI (400B) may allow the user (102) to record the audio (voice command). The user (102) may be presented with a plurality of options such as “Allow record audio”, “While using the app”, “Only this time” or “Deny”. In an aspect, the UI (400B) may allow the user (102) to provide a text input.

As illustrated in FIG. 4C, after receiving the input command from the user (102) the application may detect and provide a prompt to confirm the detected language of the input command. For example, the application automatically sets the detected language as the default language of the user. In examples, the application may also provide a list of languages to the user to select a language as an option. For example, the user (102) may be allowed to select a default language or a regional language. The user (102) may be asked for voice permission along with the geographical location of the user (102). Further, the user (102) may be asked to select the default language when no geographical location is granted by the user (102).

As illustrated in FIG. 4D, the UI (400D), the voice command of the user (102) may get processed, and a network test (e.g., speed test) may be performed by the application.

As illustrated in FIG. 4E, the UI (400E), the results of the network test may get displayed in the language selected by the user (102). For example, the result of the network test may be displayed in the default language when the default language is selected by the user (102). For example, the result of the network test may be displayed in a regional language when the regional language is selected by the user (102), and the location information is provided by the user (102). For example, the network test comprised of a video streaming test, an internet speed test, or a web performance test. For example, when the speed test is performed, the results may be displayed, including ‘Download speed’, ‘Upload speed’, and ‘Latency’. In an aspect, the video streaming test involves testing a video streaming service that involves evaluating various aspects such as video quality, streaming speed, reliability, user interface, and overall performance of the video streaming service. In an aspect, the internet speed test measures the user's internet connection's download speed (i.e., how fast data is transferred from the internet to the user's device), upload speed (i.e., how fast data is transferred from user's device to the internet), and ping (i.e., the time it takes for data to travel from user's device to the server and back). When conducting an internet speed test, latency, often referred to as ‘ping’, and it measures the time it takes for a data packet to travel from the user device (104) to the server on the internet and back again. It is typically measured in milliseconds (ms).

In an aspect, during the speed test, whenever the user (102) start the speed test, depending on the location of the user (102), a nearest server (e.g., testing server) of that location is fetched. The connection of the user device (104) with the server is made and the speed test will get performed. In an aspect speed test will be performed for latency, uplink (UL) speed and downlink (DL) speed. The nearest server is identified to avoid reducing high latency.

In an aspect, the speed test is performed for communication networks such as LTE, Wi-Fi and New radio (NR)/5G.

In an aspect, depending upon the threshold values of the parameters such as DL speed and the UL speed, the speed test may be concluded as ‘Poor’, ‘Good’ and ‘Excellent’.

Further, the threshold values of the parameters such as DL speed and the UL speed are different for LTE, Wi-Fi and 5G.

Other exemplary threshold values not disclosed are contemplated herein. In an aspect, the threshold values of the LTE and Wi-Fi are provided in Table 1.

TABLE 1

| For LTE and Wi-Fi | Result |
|---|---|
| For DL | |
| DL Values <=2.0 Mbps | Poor |
| DL Values >2.0 Mbps and <=8.0 Mbps | Good |
| DL Value >8 Mbps | Excellent |
| For UL | |
| UL Values <=0.256 Mbps | Poor |
| UL Values >0.256 Mbps and <=1 Mbps | Good |
| UL Value >1 Mbps | Excellent |

In an aspect, the threshold values of the NR/5G are provided in Table 2.

TABLE 2

| For 5G | Result |
|---|---|
| For DL | |
| DL Values <=20 Mbps | Poor |
| DL Values >20 Mbps and <=50 Mbps | Good |
| DL Value >50 Mbps | Excellent |
| For UL | |
| UL Values <=10 Mbps | Poor |
| UL Values >10 Mbps and <=15 Mbps | Good |
| UL Value >15 Mbps | Excellent |

FIG. 4F indicates a web (website) performance test. The web performance test validates the health of the various sites in terms of loading of first bite, Domain Name System (DNS) resolution time and the time taken to load an entire site (TTL). The DNS resolution time refers to the duration it takes for a DNS server to process a DNS query and provide a response with the corresponding IP address for a given domain name. In an aspect, the web performance test involves evaluating various aspects of a website's performance, including load times, responsiveness, and scalability.

FIG. 4G indicate the results of the web performance test. In an aspect, depending on the threshold values received for the parameters such as DNS, First Bite, and the TTL a conclusion for a particular site can be drawn and the result of the web performance test may be concluded as a pass or fail.

In an aspect, if (DNS resolution if get (No time out) and First Byte if get (No time out) and TTL<5000 ms)=>Pass

If (DNS resolution if get (time out) and First Byte if get (time out) and TTL>5000 ms)=>Fail

FIG. 4H shows the execution of the video test. While network speed impacts the user's video experience, providers around the world sometimes limit the resolution or prioritize video traffic differently than other traffic. This is one of the reasons why video test is an important part of any network bandwidth test. The video test in application helps to measure the quality of streaming experience. The video test may be available for the user (102) in an application.

In an aspect, the streamed video content is typically delivered via adaptive bitrate (ABR) technology, which adjusts the quality of the video stream based on network conditions. The ABR technology is a technique used in streaming media delivery to adjust the quality of video or audio streams in real-time based on the available network conditions and device capabilities. The primary goal of ABR is to provide a smooth and uninterrupted viewing or listening experience to users by dynamically adapting to fluctuations in network bandwidth, latency, and device performance. A video test measures this adaptive bitrate to tell the user the maximum resolution, the load time and buffer that the user should be able to expect in a given current network conditions.

In an aspect, an accurate video test measurement requires an actual video to be played, because video traffic cannot be simulated across a network. The video test plays an actual video to specifically measure the performance of the video streaming. Apart from adaptive bit rate, the user will also have functionality to select resolution from a resolution list as shown in mock-ups. Any resolution can be selected manually. In an aspect, the user in an Auto mode will experience the resolution supported by its network and if the user moves to a poor network in the auto mode, buffering can be experienced until the auto mode adjusts it in lower resolution.

FIG. 4I shows a result page of the video test. Below are the resolution supported and the parameters captured for the video test:
Resolution—144, 240, 360, 480, 540, 720, 1080, 1440, 2160
Buffering, Stalling, Playback time, Freezing ratio, Test Duration, Reference Signal Received Power (RSRP), Signal-to-Interference-plus-Noise Ratio (SINR), Cell ID, Load Time, and Network Type.

The stalling in video streaming refers to a disruption in the continuous playback of video content, often resulting in buffering or freezing of the video stream. Stalling can occur due to various reasons, including network congestion, insufficient bandwidth, server issues, or client-side problems. The freezing ratio is a metric used to quantify the frequency or extent of freezing or buffering events during video playback. Freezing or buffering occurs when video playback temporarily stops due to insufficient data being buffered, typically caused by network congestion, insufficient bandwidth, or server issues. The SINR provides insight into the quality of the received signal by considering both the desired signal strength and the interference and noise present in the environment.

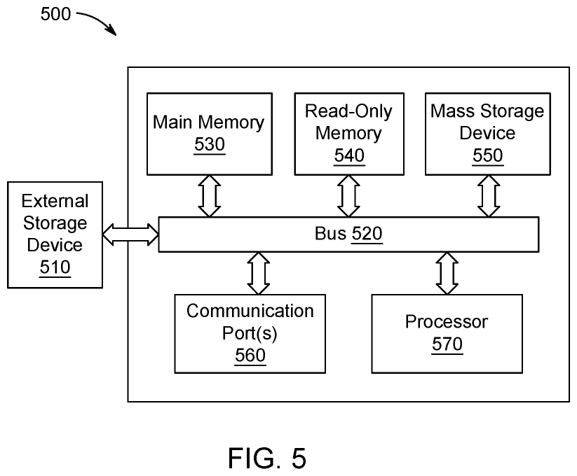

FIG. 5 illustrates an example computer system (500) in which or with which the embodiments of the present disclosure may be implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

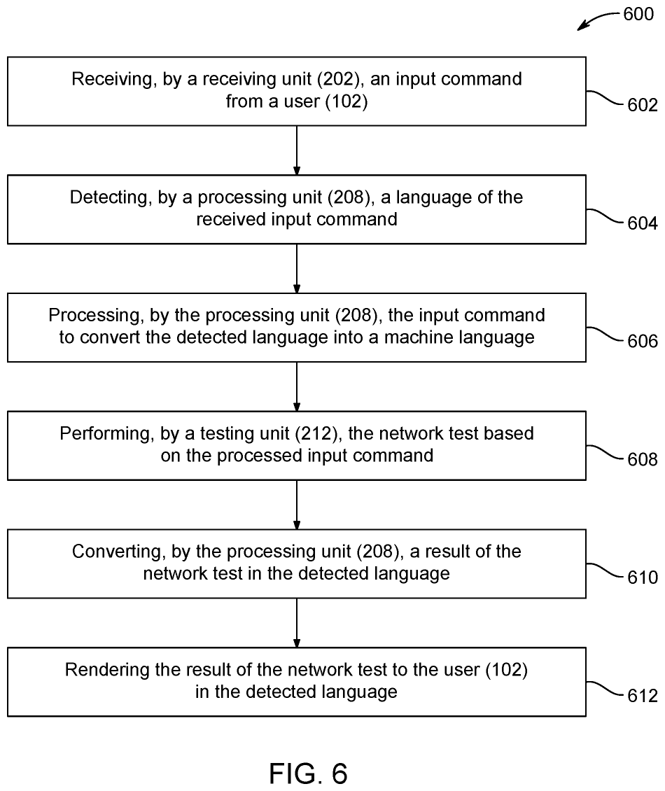

FIG. 6 illustrates a flow diagram of a method for performing a network test, in accordance with an embodiment of the present disclosure.

At step 602, the method comprising, receiving, by a receiving unit, an input command from a user.

At step 604, the method comprising, detecting, by a processing unit, a language of the received input command.

At step 606, the method comprising processing, by the processing unit, the input command to convert the detected language into a machine language.

At step 608, the method comprising, performing, by a testing unit, the network test based on the processed input command.

At step 610, the method comprising, converting, by the processing unit, a result of the network test in the detected language.

At step 612, the method comprises, rendering the result of the network test to the user in the detected language.

In an embodiment, the method further comprising providing a list of options to the user to select the language for performing the network test. In an embodiment, the selected language comprises of at least one of a default language and a regional language of the user. In an embodiment, the input command includes at least one of a voice input and a text input. In an embodiment, prior to receiving the voice input, the method comprises installing a voice assistant configured to be activated based on at least one of the voice input from the user and the geographical location of the user. In an embodiment, the voice input comprising of a plurality of instructions to perform the network test. In an embodiment, the method further comprising performing a natural language processing (NLP) on the voice input and using a geographical location of the user to detect the language of the voice input. In an embodiment, the network test comprising at least one of a video streaming test, an internet speed test, and a web performance test. In an embodiment, the network test is performed for at least one of a long term evolution (LTE), Wi-Fi and a 5G communication network. In an embodiment, the result of the network test depends on at least one threshold value associated with at least one parameter related to the network test. In an embodiment, the at least one parameter is different for the video streaming test, the internet speed test, and the web performance test. In an embodiment, the at least one threshold value associated with the at least one parameter is different for the LTE, Wi-Fi and the 5G communication network.

In an exemplary embodiment, the present disclosure discloses a user device for performing a network test. The user device comprising a receiving unit configured to receive an input command from a user, a database configured to store the received input command. The user device comprising a processing unit and a testing unit coupled to the receiving unit and the database. The processing unit configured to detect a language of the received input command and process the input command to convert the detected language into a machine language. The testing unit configured to configured to perform the network test based on the processed input command. The processing unit configured to convert a result of the network test in the detected language and render the result of the network test to the user in the detected language.

The present disclosure is applicable to 2G, 3G, 4G, 5G, 6G and beyond all generation of mobile technology with multiple bands and carriers of telecom operators. The present disclosure will help the field engineers to take quick action and perform network performance test after deploying their solutions on the field. The present disclosure will make easy for field engineer (belonging to remote location) to understand the output of the network test in their regional language. The present disclosure allows the field engineer to understand the network test related output in a better way. The present disclosure will also help the user to reduce field engineer effort, where they can perform network related tests on voice command.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a user device and a method where the use of voice assistance technology in the mobile application enables field engineers and end users to perform network performance tests more efficiently.

The present disclosure provides a user device and a method accepting user input (either in a voice input or a text input) in their regional language catering to a wider user base and ensures better user understanding. Users can comfortably communicate and interact with the application, making it more accessible and user-friendly.

The present disclosure provides a user device and a method displaying network test results in the user's language to enhance their understanding of network conditions.

The present disclosure provides a user device and a method educating users about network conditions in their area for allowing them to identify network operators with favourable performance parameters.

The present disclosure provides a user device and a method that allows flexibility to the users to personalize their language preferences based on their comfort and requirements.

The present disclosure provides a user device and a method that efficiently process voice commands and execute network tests based on user input.

The present disclosure provides a user device and a method covering a range of network tests, including speed tests, video tests, and website performance tests to evaluate different aspects of network performance.

1. A method for performing a network test, the method comprising:
receiving, by a receiving unit, an input command from a user;
detecting, by a processing unit, a language of the received input command;
processing, by the processing unit, the input command to convert the detected language into a machine language;
performing, by a testing unit, the network test based on the processed input command;
converting, by the processing unit, a result of the network test in the detected language; and
rendering the result of the network test to the user in the detected language.

2. The method as claimed in claim 1, further comprising providing a list of options to the user to select a language for performing the network test.

3. The method as claimed in claim 2, wherein the selected language comprises of at least one of a default language and a regional language of the user.

4. The method as claimed in claim 1, wherein the input command includes at least one of a voice input and a text input.

5. The method as claimed in claim 4, wherein prior to receiving the voice input, the method comprises installing a voice assistant configured to be activated based on at least one of the voice input from the user and a geographical location of the user.

6. (canceled)

7. The method as claimed in claim 4, further comprising performing a natural language processing (NLP) on the voice input and using a geographical location of the user to detect the language of the voice input.

8. The method as claimed in claim 1, wherein the network test comprising at least one of a video streaming test, an internet speed test, and a web performance test.

9. The method as claimed in claim 1, wherein the network test is performed for at least one of a long term evolution (LTE), Wireless Fidelity (Wi-Fi) and a fifth-generation (5G) communication network.

10. The method as claimed in claim 9, wherein the result of the network test depends on at least one threshold value associated with at least one parameter related to the network test, wherein the at least one threshold value associated with the at least one parameter is different for the LTE, Wi-Fi and the 5G communication network.

11. (canceled)

12. A user device for performing a network test, the user device comprising:
a receiving unit configured to receive an input command from a user;
a database configured to store the received input command;
a processing unit and a testing unit coupled to the receiving unit and the database, wherein the processing unit is configured to:
detect a language of the received input command;
process the input command to convert the detected language into a machine language;
wherein the testing unit is configured to:
perform the network test based on the processed input command;
wherein the processing unit is further configured to:
convert a result of the network test in the detected language; and
render the result of the network test to the user in the detected language.

13. The user device as claimed in claim 12, is further configured to provide a list of options to the user to select the language for performing the network test.

14. The user device as claimed in claim 13, wherein the selected language comprises of at least one of a default language and a regional language of the user.

15. The user device as claimed in claim 12, wherein the input command includes at least one of a voice input and a text input.

16. The user device as claimed in claim 15, wherein prior to receiving the voice input, the user device is configured to install a voice assistant configured to be activated based on at least one of the voice input from the user and a geographical location of the user.

17. (canceled)

18. The user device as claimed in claim 15, is further configured to perform a natural language processing (NLP) on the voice input and using a geographical location of the user to detect the language of the voice input.

19. (canceled)

20. The user device as claimed in claim 12, wherein the network test is performed for at least one of a long term evolution (LTE), Wireless Fidelity (Wi-Fi) and a fifth-generation (5G) communication network.

21. The user device as claimed in claim 20, wherein the result of the network test depends on at least one threshold value associated with at least one parameter related to the network test, wherein the at least one threshold value associated with the at least one parameter is different for the LTE, Wi-Fi and the 5G communication network.

22. (canceled)

23. A computer program product comprising a non-transitory computer-readable medium comprising instructions that, when executed by one or more processors, cause the one or more processors to perform a method for performing a network test, the method comprising:
receiving, by a receiving unit, an input command from a user;
detecting, by a processing unit, a language of the received input command;
processing, by the processing unit, the input command to convert the detected language into a machine language;
performing, by a testing unit, the network test based on the processed input command;
converting, by the processing unit, a result of the network test in the detected language; and
rendering the result of the network test to the user in the detected language.
